(19) United States
(12) Patent Application Publication
(10) Pub. No.: US 2025/0348190 A1
(43) Pub. Date: Nov. 13, 2025

(54) GRAPHICAL USER INTERFACE FOR GENERATIVE MODELS WITH DYNAMIC PROMPT ADJUSTMENT

(71) Applicant: GOOGLE LLC, Mountain View, CA (US)

(72) Inventors: Cliff Kuang, San Francisco, CA (US); Micah Lemonik, Great Neck, NY (US); John Richter, Boulder, CO (US); Bobby Soares, New York, NY (US); Antonio Gaetani, Kilchberg (CH)

(21) Appl. No.: 18/811,322

(22) Filed: Aug. 21, 2024

Related U.S. Application Data
(60) Provisional application No. 63/645,909, filed on May 12, 2024.

(51) Int. Cl. G06F 3/0482; G06F 3/0484; G06F 40/20

(52) U.S. Cl. CPC G06F 3/0482; G06F 3/0484; G06F 40/20

(57) ABSTRACT

Processor(s) of a system can: receive user input; process, using a generative model (GM), a GM input based upon the user input to generate a first GM output that includes a first set of items associated with a corresponding prompt for subsequent processing by the GM; cause the first set of items to be visually rendered using a first set of GUI elements; in response to receiving a user selection of a GUI element corresponding to an item of the first set of items, process, using the GM, the prompt associated with the selected item to generate second GM output that includes a second set of items; cause the second set of items to be visually rendered using a second set of GUI elements; and determine updated prompt(s) associated with the first set of items based upon a user interaction with the second set of GUI elements.

### BACKGROUND

Various generative models have been proposed that can be used to process natural language (NL) content and/or other input(s), to generate output that reflects generative content that is responsive to the input(s). For example, large language models (LLMs) and their multi-modal counterparts are powerful generative machine learning models that can be used to generate output from user input in order to perform a diverse set of tasks. LLMs are typically trained on enormous amounts of diverse data including data from, but not limited to, webpages, electronic books, software code, electronic news articles, and machine translation data. Accordingly, these LLMs leverage the underlying data on which they were trained in performing these various natural language processing (NLP) tasks. For instance, in performing a language generation task, these LLMs can process a natural language (NL) based input that is received from a client device, and generate a response that is responsive to the NL based input and that is to be rendered at the client device.

Typically, a user interacts with an LLM via a dialog sequence in a chat-style interface. However, this type of linear interface can be sub-optimal for carrying out many tasks. In particular, as the dialog progresses, previous dialog turns will disappear off-screen. A user will then have to scroll back through dialog sequence to view previous responses. A user may also want to refer back to a particular LLM response and given the chat-style interface, it can be difficult for a user to find the particular response. It is therefore beneficial to provide an improved interface for users to interact with LLMs and generative models.

### SUMMARY

Implementations described herein relate to graphical user interfaces for generative models (GMs). In particular, elements of a GUI can be associated with prompts for processing by the GM and the prompts can be dynamically adjusted based upon user interaction with GUI elements. Processor(s) of a system can: receive user input associated with a user of a client device; process, using a generative model, a generative model input based upon the user input to generate a first generative model output that comprises a first set of items, wherein each item of the first set of items is associated with a corresponding prompt for subsequent processing by the generative model; cause the first set of items to be visually rendered at the client device using a first set of GUI elements; in response to receiving a user selection of a GUI element corresponding to an item of the first set of items, process, using the generative model, the prompt associated with the selected item to generate second generative model output that comprises a second set of items; cause the second set of items to be visually rendered at the client device using a second set of GUI elements; and determine an update for at least one prompt associated with the first set of items based upon a user interaction with the second set of GUI elements.

Users typically interact with GMs such as LLMs, using a dialog sequence in a chat-style user interface. However, such interfaces can be sub-optimal when attempting to carrying out tasks that can have multiple steps, options or dependencies. For example, an LLM can generate an initial set of sub-tasks in response to a first user query. A user may then choose to carry out the first sub-task and input further queries to the LLM regarding the first sub-task which the LLM provides responses to. Once that sub-task has been completed, it is likely that the initial LLM response with the list of sub-tasks has displaced off-screen. The user will then have to scroll back through the dialog sequence to find the initial list of sub-tasks or the user has to prompt the LLM to re-generate the list of tasks. In some cases, an option selected for one sub-task can constrain the options for another sub-task. If a user cannot recall what option was selected, the user will have to scroll back through the dialog sequence to find the particular previous dialog or prompt the LLM to remind them of the selected option. Furthermore, LLMs typically have a limited context window and thus, re-prompting to obtain previously generated information can cause the LLM to forget earlier information as well as unnecessarily incurring computational costs in handling such queries.

The techniques described herein provide a graphical user interface for generative models whereby a first set of items, e.g., a list of sub-tasks, output by a generative model is displayed at a user device using a first set of GUI elements. Each item is associated with a corresponding prompt for subsequent processing by the generative model when the GUI element for that item is selected. For example, the prompt can instruct the generative model to generate a set of further items/options related to carrying out the selected sub-task and these further items can also be rendered in GUI form. When the user interacts with the GUI elements for the further set of items, the system can determine an update to the relevant prompts associated with the first set of items. For example, a selection of an item from the further set of items can impose a constraint on the valid options for other sub-tasks. The relevant prompts for those sub-tasks (first set of items) can be updated to include such constraints and as such, when the user comes to interact with the GUI element for that sub-task, the generative model can run the updated prompt and present only the valid options to the user in response.

In this way, the set of GUI elements provides graphical shortcuts for initiating processing by the generative model. These graphical shortcuts are dynamically updated according to the user's interaction with the interface and the system provides a continued and guided human computer interaction for carrying out a task. The user does not have to attempt to formulate their own prompts. The system can reduce the amount of user interaction needed with the device as the GUI can provide an improved organizational layout for viewing generative model output compared to a traditional linear chat-style interface where the dialog can quickly disappear off-screen. Computational resources can be saved from a user not having to re-prompt the generative model unnecessarily. The techniques described herein therefore provide an overall improved user interface for generative models.

In some implementations, a GM can include at least hundreds of millions of parameters. In some of those implementations, the GM includes at least billions of parameters, such as one hundred billion or more parameters. In some additional or alternative implementations, a GM is a sequence-to-sequence model, is Transformer-based, and/or can include an encoder and/or a decoder. Non-limiting examples of GMs include Bard, Gemini, GPT, PaLM, LaMDA etc. It should be noted that the GMs described herein are not intended to be limiting.

The above description is provided as an overview of some implementations of the present disclosure. Further description of those implementations, and other implementations, are described in more detail below.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts an example process flow of providing a GUI for generative models using various components from FIG. 1, in accordance with various implementations.

FIG. 3A, FIG. 3B, FIG. 3C, FIG. 3D, FIG. 3E, FIG. 3F, and FIG. 3G depict various non-limiting example GUIs, in accordance with various implementations.

FIG. 4 depicts a block diagram depicting an example of dynamic prompt adjustment, in accordance with various implementations.

FIG. 5 depicts a flowchart illustrating an example method of providing a GUI for generative models with dynamic prompt adjustment, in accordance with various implementations.

FIG. 6 depicts an example architecture of a computing device, in accordance with various implementations.

### DETAILED DESCRIPTION OF THE DRAWINGS

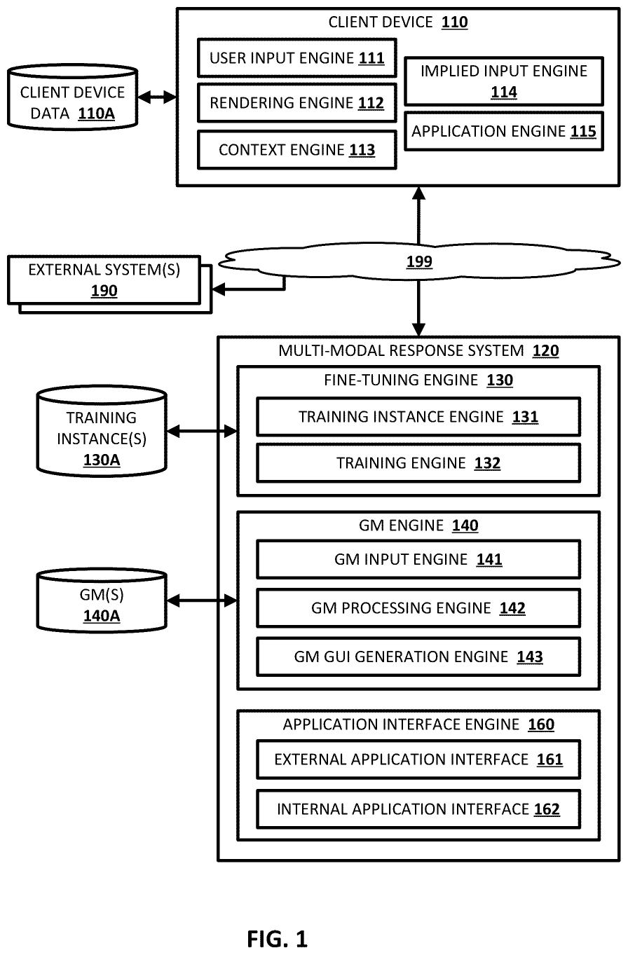

Turning now to FIG. 1, a block diagram of an example environment that demonstrates various aspects of the present disclosure, and in which implementations disclosed herein can be implemented is depicted. The example environment includes a client device 110 and a multi-modal response system 120. In some implementations, all or aspects of the multi-modal response system 120 can be implemented locally at the client device 110. In additional or alternative implementations, all or aspects of the multi-modal response system 120 can be implemented remotely from the client device 110 as depicted in FIG. 1 (e.g., at remote server(s)). In those implementations, the client device 110 and the multi-modal response system 120 can be communicatively coupled with each other via one or more networks 199, such as one or more wired or wireless local area networks (“LANs,” including Wi-Fi, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more software applications, via application engine 115, through which multi-modal input can be submitted and/or multi-modal responses and/or other responses (e.g., uni-modal responses) that are responsive to the multi-modal input can be rendered (e.g., audibly and/or visually). The application engine 115 can execute one or more software applications that are separate from an operating system of the client device 110 (e.g., one installed “on top” of the operating system)—or can alternatively be implemented directly by the operating system of the client device 110. For example, the application engine 115 can execute a web browser or automated assistant installed on top of the operating system of the client device 110. As another example, the application engine 115 can execute a web browser software application or automated assistant software application that is integrated as part of the operating system of the client device 110. The application engine 115 (and the one or more software applications executed by the application engine 115) can interact with or otherwise provide access to (e.g., as a frontend) the multi-modal response system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to typed and/or touch inputs directed to the client device 110.

Some instances of an input prompt described herein can be provided by a user of the client device 110 and detected via user input engine 111. For example, the input prompt can be typed via a physical or virtual keyboard, be a suggestion displayed by the client device 110 that is selected via a touch screen or a mouse of the client device 110, be speech that is detected via microphone(s) of the client device 110 (and optionally directed to an automated assistant executing at least in part at the client device 110). An image or video input can be based on vision data captured by vision component(s) of the client device 110, or be obtained from an application such as a web browser or photograph collection.

In various implementations, the client device 110 can include a rendering engine 112 that is configured to render content (e.g., uni-modal responses, multi-modal responses, an indication of source(s) associated with portion(s) of the uni-modal and/or multi-modal responses, and/or other content) for audible and/or visual presentation to a user of the client device 110 using one or more user interface output devices. For example, the client device 110 can be equipped with one or more speakers that enable audible content to be provided for audible presentation to the user via the client device 110. Additionally, or alternatively, the client device 110 can be equipped with a display or projector that enables textual content or other visual content (e.g., image(s), video(s), etc.) to be provided for visual presentation to the user via the client device 110.

In various implementations, the client device 110 can include a context engine 113 that is configured to determine a client device context (e.g., current or recent context) of the client device 110 and/or a user context of a user of the client device 110 (or an active user of the client device 110 when the client device 110 is associated with multiple users). In some of those implementations, the context engine 113 can determine a context based on data stored in client device data database 110A. The data stored in the client device data database 110A can include, for example, user interaction data that characterizes current or recent interaction(s) of the client device 110 and/or a user of the client device 110, location data that characterizes a current or recent location(s) of the client device 110 and/or a geographical region associated with a user of the client device 110, user attribute data that characterizes one or more attributes of a user of the client device 110, user preference data that characterizes one or more preferences of a user of the client device 110, user profile data that characterizes a profile of a user of the client device 110, and/or any other data accessible to the context engine 113 via the client device data database 110A or otherwise.

For example, the context engine 113 can determine a current context based on a current state of a dialog session (e.g., considering one or more recent inputs provided by a user during the dialog session), profile data, and/or a current location of the client device 110. For instance, the context engine 113 can determine a current context of “visitor looking for upcoming events in Louisville, Kentucky” based on a recently issued query, profile data, and an anticipated future location of the client device 110 (e.g., based on recently booked hotel accommodations). As another example, the context engine 113 can determine a current context based on which software application is active in the foreground of the client device 110, a current or recent state of the active software application, and/or content currently or recently rendered by the active software application. A context determined by the context engine 113 can be utilized, for example, in supplementing or rewriting NL based input that is formulated based on user input, in generating an implied NL based input (e.g., an implied query or prompt formulated independent of any explicit NL based input provided by a user of the client device 110), and/or in determining to submit an implied NL based input and/or to render result(s) (e.g., a response) for an implied NL based input.

In various implementations, the client device 110 can include an implied input engine 114 that is configured to: generate an implied NL based input independent of any user explicit NL based input provided by a user of the client device 110; submit an implied NL based input, optionally independent of any user explicit NL based input that requests submission of the implied NL based input; and/or cause rendering of search result(s) or a response for the implied NL based input, optionally independent of any explicit NL based input that requests rendering of the search result(s) or the response. For example, the implied input engine 114 can use one or more past or current contexts, from the context engine 113, in generating an implied NL based input, determining to submit the implied NL based input, and/or in determining to cause rendering of search result(s) or a response that is responsive to the implied NL based input. For instance, the implied input engine 114 can automatically generate and automatically submit an implied query or implied prompt based on the one or more past or current contexts. Further, the implied input engine 114 can automatically push the search result(s) or the response that is generated responsive to the implied query or implied prompt to cause them to be automatically rendered or can automatically push a notification of the search result(s) or the response, such as a selectable notification that, when selected, causes rendering of the search result(s) or the response. Additionally, or alternatively, the implied input engine 114 can submit respective implied NL based input at regular or non-regular intervals, and cause respective search result(s) or respective responses to be automatically provided (or a notification thereof automatically provided). For instance, the implied NL based input can be “patent news” based on the one or more past or current contexts indicating a user's general interest in patents, the implied NL based input or a variation thereof periodically submitted, and the respective search result(s) or the respective responses can be automatically provided (or a notification thereof automatically provided). It is noted that the respective search result(s) or the response can vary over time in view of, e.g., presence of new/fresh search result document(s) over time.

Further, the client device 110 and/or the multi-modal response system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household, a workplace, a hotel, etc.).

The multi-modal response system 120 is illustrated in FIG. 1 as including a fine-tuning engine 130, a GM engine 140, and an application interface engine 160. Some of these engines can be combined and/or omitted in various implementations. Further, these engines can include various sub-engines. For instance, the fine-tuning engine 130 is illustrated in FIG. 1 as including a training instance engine 131 and a training engine 132.

The training instance engine 131 can select training instances, for example, from training instance database 130A, for training a GM. In some implementations, the training instance engine 131 can also generate training instances.

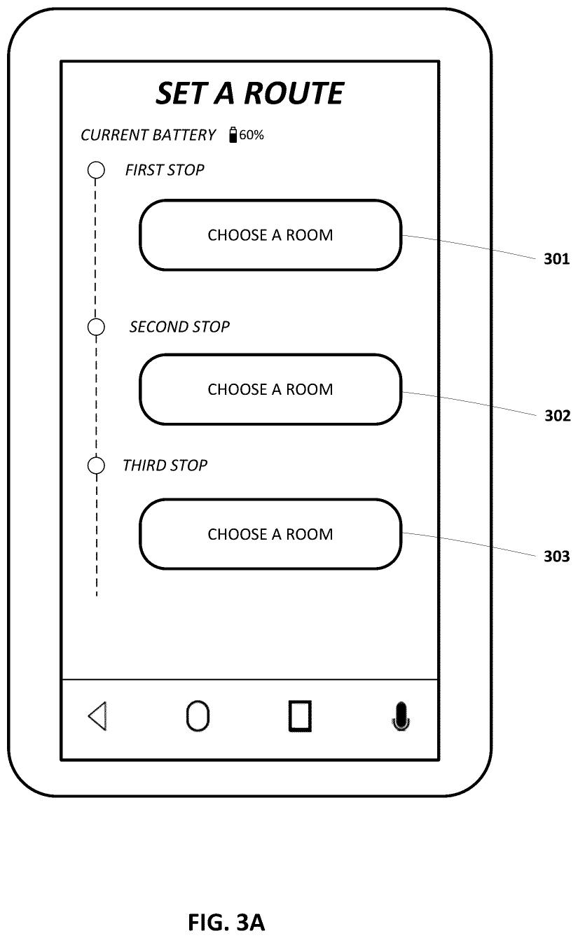

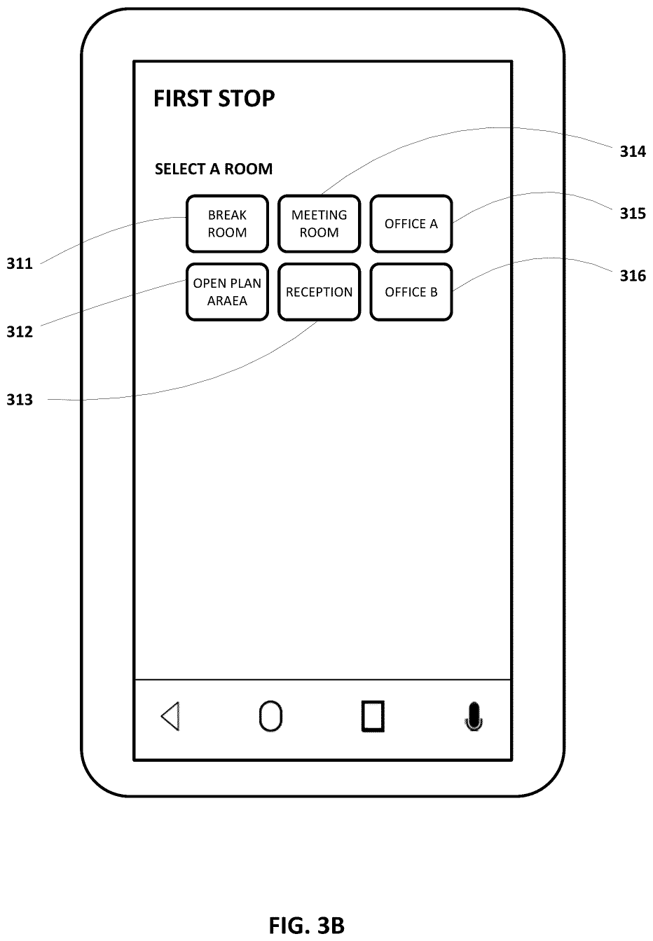

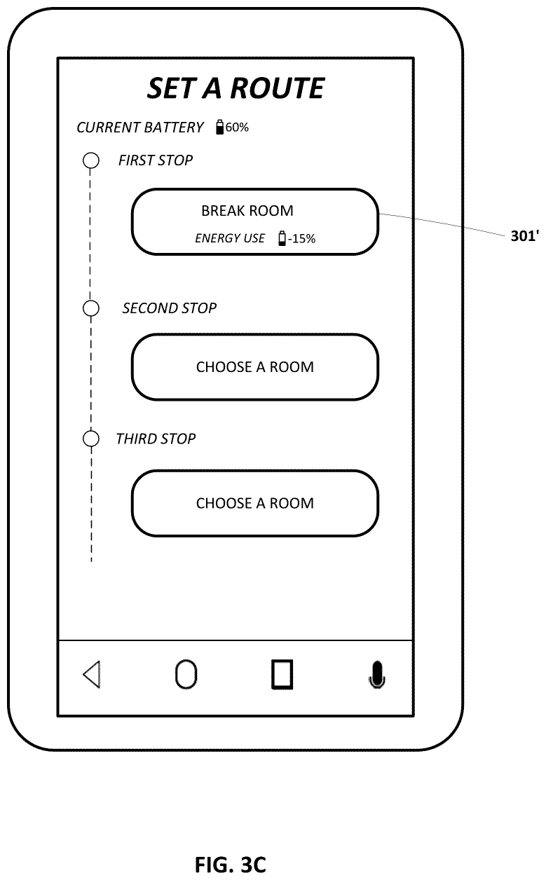

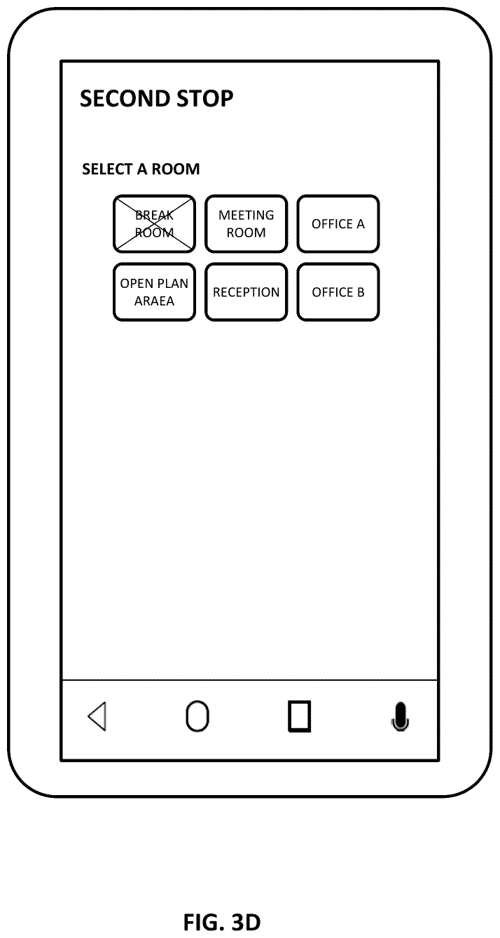

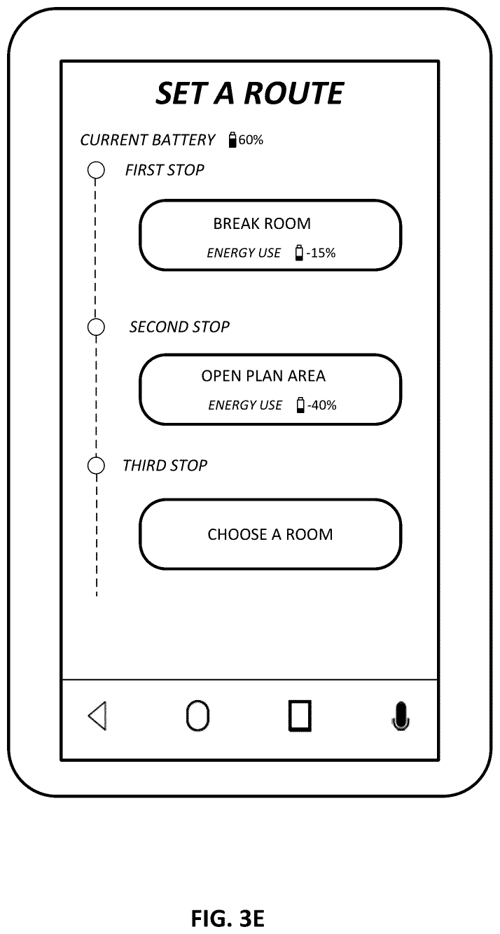

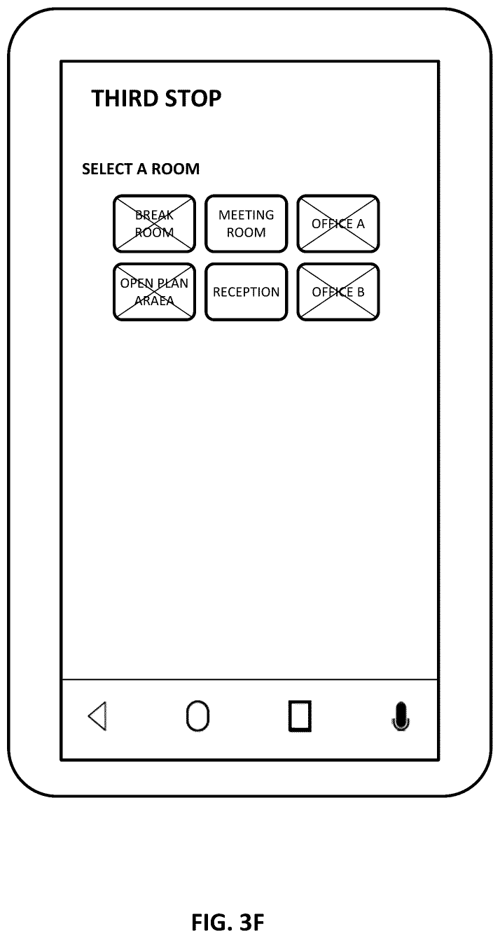

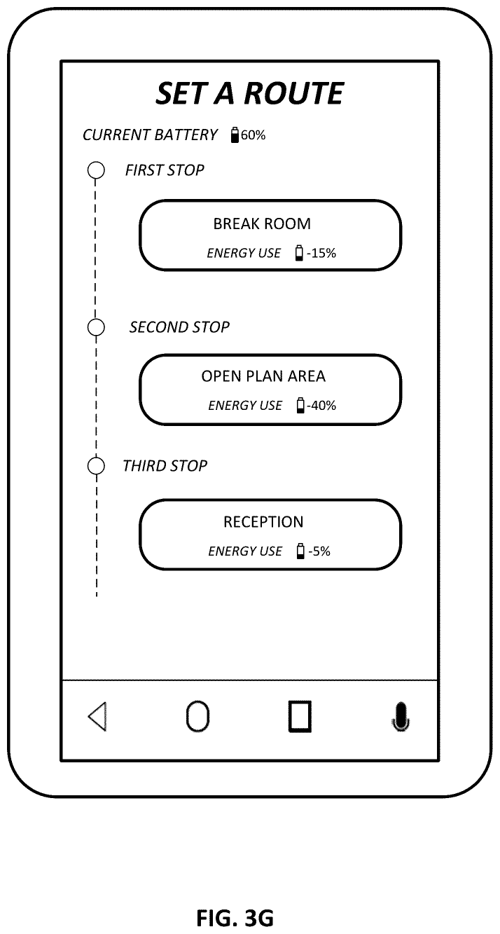

The training engine 132 can train one or more GMs using the selected training instances. For example, the training engine 132 can fine-tune the parameters of one or more GMs stored in a GM database 140A to carry out a specific task. In various implementations, the training engine 132 can perform all or aspects of method 300 of FIG. 3.

Further, the GM engine 140 illustrated in FIG. 1 includes a GM input engine 141, a GM processing engine 142, and a GM response generation engine 143.

The GM input engine 141 can, in response to receiving an input from the client device 110, carry out processing of the user input to generate GM input for processing by a GM or other engine/sub-engine. For example, the GM input engine 141 can determine a prompt for processing by a GM based upon a received user selection of a GUI element as described below.

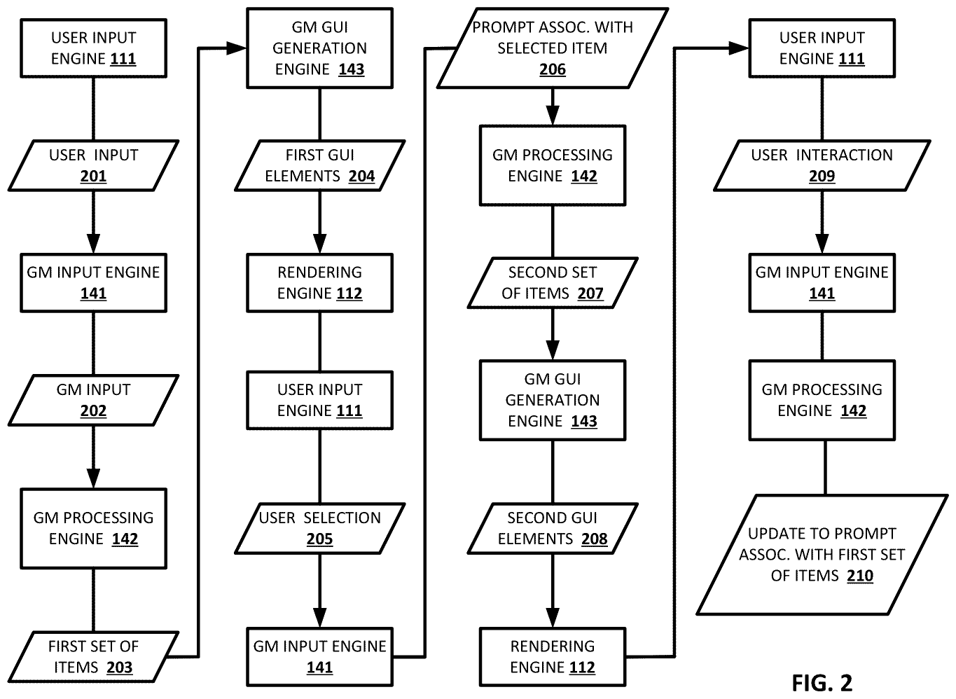

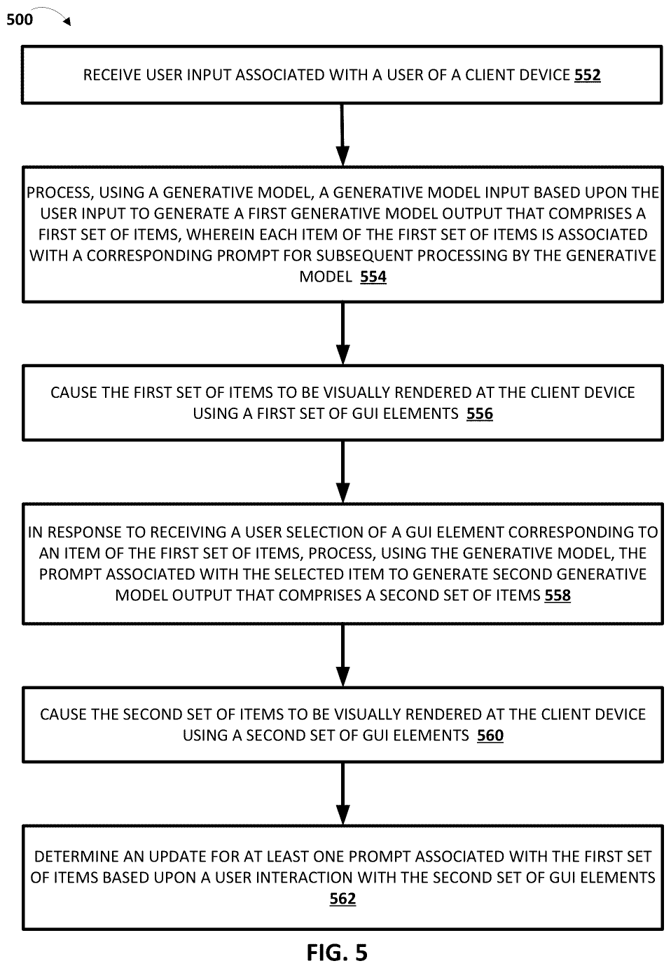

The GM processing engine 142 can, in response to receiving an input, determine which, if any, of multiple GMs to utilize in generating response(s) to render responsive to the input. The GM processing engine 142 can optionally utilize one or more classifiers and/or rules (not illustrated). The GM processing engine 142 can process the GM input that is generated by the GM input engine 141 using a selected GM to generate a response. For example, in generating a set of items in response to a prompt and then any further prompts associated with those items. The response can be a multi-modal response, for example, including image, audio and/or NL text output, or a uni-modal response as determined by the GM. In various implementations, the GM processing engine 142 can be used as indicated in FIG. 2, perform all or aspects of blocks 554, 558, and 562 of method 500 of FIG. 5.

The GM GUI generation engine 143 can determine an appropriate set of GUI elements with which the generated response can be visually rendered on the client device 110. In some implementations, the GM can select an appropriate GUI from a plurality of GUI templates and/or the GM can generate an appropriate arrangement of GUI elements for the visually rendering the response. The GM can also be used to generate the GUI elements themselves. In various implementations, the GM GUI generation engine 143 indicated in FIG. 2, performs all or aspects of blocks 556 to 560 of method 500 of FIG. 5.

Further, the application interface engine 160 illustrated in FIG. 1 includes an external application interface 161 and an internal application interface 162. The external application interface 161 can communicate with external system(s) 190 to provide additional functionality for a GM or to augment an external system with GM functionality. As an example, the external systems(s) can include robotic systems, image, video or audio generation/retrieval systems, search engines and booking systems amongst others. In some implementations, the external system(s) 190 are first-party system(s), whereas in other implementations, the external system(s) 190 are third-party system(s). As used herein, the term “first-party” refers to an entity that develops and/or maintains the multi-modal response system 120, whereas the term “third-party” or “third-party entity” refers to an entity that is distinct from the entity that develops and/or maintains the multi-modal response system 120. The internal application interface 162 can communicate with other internal systems and applications stored on the same device as the multi-modal response system 120. These internal systems and applications can provide a GM with additional functionality.

It will be appreciated that some of the sub-engines illustrated in FIG. 1 can be combined and/or omitted in various implementations. Accordingly, it should be understood that the various engines and sub-engines of the multi-modal response system 120 illustrated in FIG. 1 are depicted for the sake of describing certain functionalities and is not meant to be limiting.

Further, the multi-modal response system 120 illustrated in FIG. 1 can interface with various databases, such as training instance(s) database 130A and VLM(s) database 140A as described above. Although particular engines and/or sub-engines are depicted as having access to particular databases, it should be understood that is for the sake of example and is not meant to be limiting. For instance, in some implementations, each of the various engines and/or sub-engines of the multi-modal response system 120 may have access to each of the various databases. Further, some of these databases can be combined and/or omitted in various implementations. Accordingly, it should be understood that the various databases interfacing with the multi-modal response system 120 illustrated in FIG. 1 are depicted for the sake of describing certain data that is accessible to the multi-modal response system 120 and is not meant to be limiting.

As described in more detail herein (e.g., with respect to FIGS. 2, 3A-G, 4 and 5), the multi-modal response system 120 can be utilized to generate GUIs for visually rendering and interacting with GM responses and to dynamically adjust prompts that are associated GUI elements based upon user interactions with the GUI.

Turning now to FIG. 2, an example process flow 200 of interacting with a GM using a GUI using various components from FIG. 1 is depicted. FIGS. 3A-G provide exemplary schematic illustrations of a GUI rendered on a client device 110 which will also be referred to below. Such illustrations are not intended to be limiting.

The user input engine 111 of a client device 110 receives a user input 201. The user input 201 can be an initial user prompt for example. The initial user prompt can specify a particular task that the user wishes to perform with the aid of a GM. As an example, the GM can interface with an external system such as a robotic system to enable a user to control the robotic system. In one particular example, the user wishes to set a route for an industrial robot vacuum cleaner in an office. In this case, the user input 201 can be a prompt asking the GM to “Set a cleaning route for the robot vacuum cleaner”.

The user input 201 is received by GM input engine 141 of the multi-modal response system 120. In some implementations, the multi-modal response system 120 is remote from the client device 110 and the user input 201 is transmitted from the client device 110 to the multi-modal response system 120 over network 199. In other implementations, the multi-model response system 120 resides on the client device 110 and the user input 201 can be retrieved from a memory or storage of the client device 110.

The GM input engine 141 can generate a generative model input based upon the user input 201. For example, GM input engine 141 can carry out any pre-processing of the user input 201 such that the input can be processed appropriately by a GM. This can include operations such as tokenization and text encoding for example.

The GM processing engine 142 processes the generative model input using the GM to generate a first generative model output that comprises a first set of items. Each item of the first set of items is associated with a corresponding prompt for subsequent processing by the generative model. For instance, in the example of setting a route for the robot vacuum cleaner, from processing the generative model input, the GM can determine that communication with the external robotic system is required to retrieve the current status of the robot such as the current battery life of the robot and to retrieve floorplan data for the office. The GM can process the retrieved data from external robotic system to determine that the robot is able to carry out cleaning of three areas and can generate a route plan including three stops. As such, the first set of items can include an item for each cleaning stop. The GM can generate associated prompts to enable the user to configure each cleaning stop. In this case, the associated prompts can each be the same, for example, “Show room options for a cleaning stop on the basis of the retrieved floorplan and the current battery life of the robot is at 60%”. It will be appreciated that in general, the associated prompts can be different.

The GM GUI generation engine 143 can generate a first set of GUI elements for visually rendering the first set of items at the client device 110. The GM can be instructed to select or generate an appropriate set of GUI elements for the first set of items. The first set of GUI elements can be transmitted to the client device 110 and rendered by the rendering engine 112. The GUI elements can include selectable tiles or buttons having an appropriate text caption that is representative of the item or the associated prompt. The GUI elements can also include a representative thumbnail image which can be generated by the GM or obtained from an external system by the GM for example.

FIG. 3A shows an example illustration of a GUI rendered on the client device. The GUI includes the first set of items, “FIRST STOP”, “SECOND STOP”, and “THIRD STOP” rendered as text with a captioned button 301, 302, 303 beneath each to enable the user to configure a room option for each cleaning stop. When the user presses one of the buttons 301-303, this interaction can cause the prompt associated with that item to be processed by the GM.

Referring back to FIG. 2, the user selection of a first GUI element 205 is provided to the GM input engine 141. The GM input engine 141 can determine the prompt 206 that is associated with the selected GUI element and the GM processing engine 142 can cause the prompt 206 to be processed by the GM. The associated prompt is processed by the GM to generate second generative model output that comprises a second set of items. For example, suppose the user presses button 301 to configure the first cleaning stop. This item is associated with the prompt, “Show room options for a cleaning stop on the basis of the retrieved floorplan and the current battery life of the robot is 60%,” as discussed above. This prompt is processed by the GM to generate output indicating that possible room options are the break room, the open plan area, the meeting room, reception, office A and office B which constitutes the second set of items.

As with the first set of items, the GM GUI generation engine 143 can generate a second set of GUI elements for visually rendering at the client device to present the GM response to the user. An example GUI is shown in FIG. 3B. The second set of items are represented by selectable tiles 311-316 arranged in a grid layout. The user can select a tile to make a room selection for the first cleaning stop for the robot. For example, the user can select tile 311 to select the break room as the first cleaning stop. Such a selection can then trigger an update to the prompts associated with the second and third stops take account of the selection for the first stop.

Referring back to FIG. 2, the user interaction with the second GUI element 209 can be processed by the GM input engine 141 and the GM processing engine 142 and an update to the relevant prompts associated with the first set of items can be determined using the GM. For example, the selected item and the floorplan can be processed by the GM to estimate the amount of energy that will be consumed by the robot. For example, suppose it is determined that cleaning the break room will likely consume 15% of the battery life of the robot. The estimated energy consumption can be further processed by the GM to determine an update for the associated prompts of the other items in the first set of items. For example, the updated prompts could be, “Show room options for a cleaning stop on the basis of the retrieved floorplan, the current battery life of the robot is 45% and the first cleaning stop was the break room.” Thus, one or more constraints based upon the user interaction with the second set of GUI elements can be determined. One or more prompt updates can be determined based upon the determined one or more constraints.

In some implementations, the GM GUI generation engine 143 can also generate an update to the first set of GUI elements based upon the user interaction. For example, as shown FIG. 3C, the caption in the button 301′ for the FIRST STOP can be changed to reflect the user selection of the break room and can also provide an indication of the estimated energy use.

The user can proceed to configure the remaining stops of route plan and processing can proceed similarly to that described above. For example, the user can select button 302 for configuring the second stop. This in turn can cause the GM to process the prompt associated with the second stop to generate third generative model output including a set of room options for the second stop which, as discussed above, has been constrained based upon the selection for the first stop. A set of GUI elements can be generated for this third generative model output and can be rendered at the client device. For example, as shown in FIG. 3D, the tile for the break room is crossed-out given that has already been previously selected for the first stop.

As an example, the user proceeds to select the open plan area tile. As before, another update to the relevant prompts associated with the first set of items can be determined on the basis of this user selection. Again, the GM can be used to estimate the energy consumption for the selection and to determine an update for the relevant prompts of the first set item. For example, the energy consumption can be estimated to be 40% and the prompt associated with the third stop could be updated as, “Show room options for a cleaning stop on the basis of the retrieved floorplan, the current battery life of the robot is 5%, the first cleaning stop was the break room, and the second cleaning stop was the open plan area.”

FIG. 3E shows the route plan GUI updated with the selection of the open plan area and its estimated energy use for the second stop. The user can then configure the option for the third cleaning stop by selecting the appropriate button. As before, selection of the button can initiate processing of the associated prompt by the GM. The output of the GM can then be rendered in GUI form at the client device. An example is shown in FIG. 3F whereby the tiles for the break room, open plan area, office A and office B have been crossed out as these are no longer valid options given the previous selections for the first and second stop and the estimated remaining battery life of the robot.

FIG. 3G shows an example GUI representation of the completed route plan. In some implementations, the multi-modal response system 120 can communicate the route plan to the external robotic system to cause the robot to navigate the specified areas according to the route plan.

It will be appreciated that the GUI enables a non-linear interaction with the GM. For example, in view of the high energy consumption for the open plan area, the user could choose to change the first stop. In response to the selection of the open plan area, as well as updating the prompt associated with the third stop, the prompt associated with the first stop can also be updated with the second stop selection and its estimated energy consumption. In this way, if the user chooses to press the first stop button again, the GM can run the updated prompt for the first stop that takes into account the second stop selection and its estimated energy usage. Any new selection for the first stop can also cause the prompts associated with the other stops to be updated accordingly.

In the above example, the user interaction with the GUI elements for the configuring the first stop resulted in updates for the prompts associated with the second and third stops. That is, the prompt to be updated is different to the prompt corresponding to the selected GUI element of the first set of GUI elements. In some implementations, it is possible that the same prompt corresponding to the selected GUI element of the first set of GUI elements is updated.

In the above example, a single selection is made when configuring each of the stops. In some implementations, it is possible that a plurality of selections/interactions with GUI elements can be made. Some or all of these selections/interactions can result in updates to one or more associated prompts.

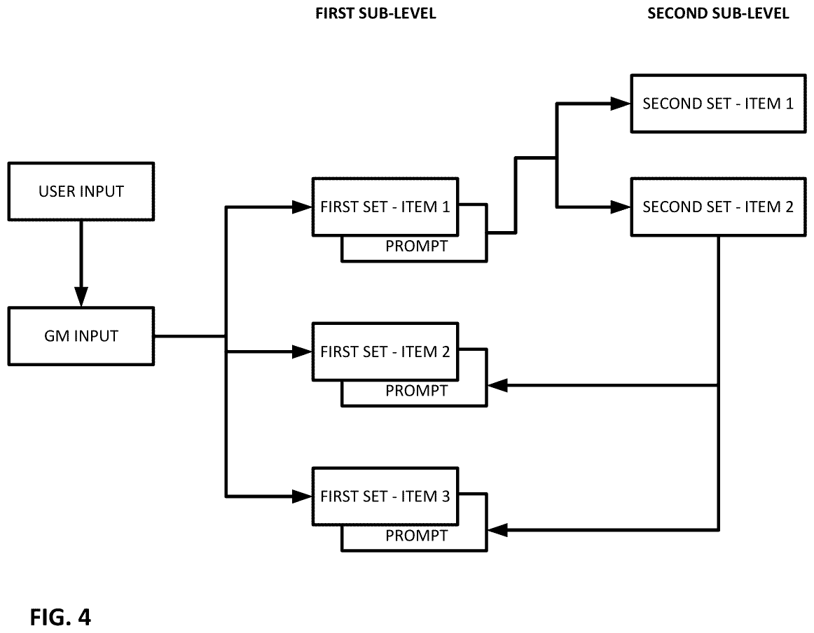

In the above example, there is an overall task of configuring a route for a robot with a first sub-level relating to a stop on the route (the first set of items) and for each stop, a second sub-level to select a room for the stop (the second set of items). This is illustrated further in FIG. 4. In some implementations, there can be further sub-levels. Items in any sub-level can have an associated prompt. For example, the second set of items (in the second sub-level) can also be associated with corresponding additional prompts for subsequent processing by the GM. A user interaction with the GUI elements at any sub-level can cause an update to be generated for a prompt at the same or any other sub-level.

In some implementations, an item can be associated with a plurality of sub-prompts and determining an update for a prompt can include determining an update for at least one sub-prompt of the plurality of sub-prompts.

In some implementations, an updated prompt can be processed pre-emptively prior to the user selecting the GUI element that initiates running the updated prompt. In this way, the latency can appear reduced for the user.

It will be appreciated that the above example of a robot vacuum cleaner and the GUI shown in FIGS. 3A-G is not intended to be limiting. The system can be used in connection with any other appropriate task. For example, other tasks can include allocation of resources on a computing system, e.g., the allocation of jobs to processing nodes with constraints based upon processor, memory and/or storage requirements of each job. Other tasks can include the control of manufacturing processes for manufacturing a mechanical, chemical, biological or food product, including any intermediate elements. These can be constrained by the consumption of resources such as electricity, water, raw materials and other consumables in the manufacturing process. Other tasks can include the control or maintenance of equipment in service facilities, such as a data center, including temperature controls, air flow and air conditioning for example.

The system can also be used to help users with more general tasks, for example, to help a user with planning a vacation or a birthday party. The system can interface with external systems to enable the user to view options and to book a table for a restaurant at a particular location, or to see what movies are showing at a theatre and to book tickets, or to view options for tourist attractions, or to view options and book appropriate transportation as examples. The system can also be used for other tasks such as to help a user with learning an instrument, or to help a user with a college application amongst others.

The GM can have any appropriate architecture. For example, the GM can include one or more Transformer blocks and can have an encoder/decoder, encoder-only or decoder-only architecture.

A GM can be trained on large amounts of data including data from, but not limited to, webpages, electronic books, software code, electronic news articles, and machine translation data. Unsupervised or self-supervised learning can be used for training. For example, a next token prediction task and/or a masked token prediction task can be used. In some implementations, the GM can be trained on uni-modal data and multi-modal data. For multi-modal training, the GM can be trained using corresponding image and text pairs. For example, these can be obtained from alt-text for images on webpages. Next token prediction and masked token prediction can also be used for multi-modal training. For example, the task can involve prediction of a caption for a particular image. Other tasks can include a matching task, for example, determining whether a particular text caption matches a particular image or vice versa. Similar training can be carried out for other modalities.

A GM may undergo further training to improve the GM's ability to respond to user prompts and queries. For example, supervised fine-tuning (SFT) and/or reinforcement learning with human feedback (RLHF) can be used. In SFT, a high-quality dataset including examples of input prompts and corresponding responses (which may be multi-modal) can be used. This data is typically generated by human annotators, though this data can be augmented by using the models themselves to generate further examples using human annotated data as seeds. The GM can be trained using supervised learning to generate the corresponding responses from the input prompt. In RLHF, a reward model can be trained from human preference data regarding different outputs generated from the same input prompt and reinforcement learning used to update the parameters of the GM based upon the reward values provided by the trained reward model.

A GM can be fine-tuned to carry out the above-described GM GUI interaction techniques using any appropriate training technique such as SFT and RLHF. In some implementations, fine-tuning of a GM is not required and a GM can be instructed with appropriate prompts to generate the required output. The prompts can include one or more examples (or descriptions of examples) that the GM should output to provide guidance for the GM.

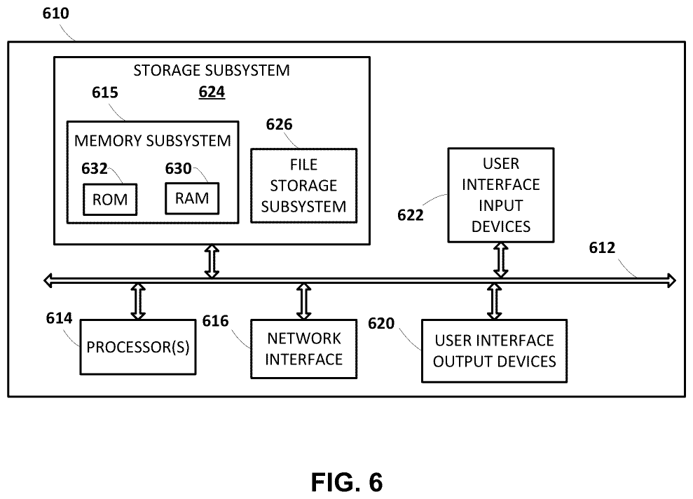

Turning now to FIG. 5, a flowchart illustrating an example method 500 of interacting with a GM using a GUI with dynamic prompt adjustment is shown. For convenience, the operations of the method 500 are described with reference to a system that performs the operations. This system of the method 500 includes one or more processors, memory, and/or other component(s) of computing device(s) (e.g., client device 110 of FIG. 1, multi-modal response system 120 of FIG. 1, computing device 610 of FIG. 6, one or more servers, and/or other computing devices). Moreover, while operations of the method 500 are shown in a particular order, this is not meant to be limiting. One or more operations may be reordered, omitted, and/or added.

At block 552, the system receives user input associated with a user of a client device. For example, the user input can be an initial user prompt. The initial user prompt can specify a particular task that the user wishes to perform with the aid of a GM.

At block 554, the system processes, using a generative model, a generative model input based upon the user input to generate a first generative model output that comprises a first set of items. Each item of the first set of items is associated with a corresponding prompt for subsequent processing by the generative model. The first set of items can correspond to a set of sub-tasks with respect to the initial user prompt for example.

At block 556, the system causes the first set of items to be visually rendered at the client device using a first set of GUI elements. In some implementations, the GUI elements can include selectable tiles or buttons having an appropriate text caption that is representative of the item or the associated prompt. The GUI elements can also include a representative thumbnail image which can be generated by the GM or obtained from an external system for example.

At block 558, the system, in response to receiving a user selection of a GUI element corresponding to an item of the first set of items, processes, using the generative model, the prompt associated with the selected item to generate second generative model output that comprises a second set of items. For example, the second set of items can be options relating to a selected sub-task.

In some implementations, to generate the second generative model output (or any other generative model output) the system can invoke an external application based upon processing the prompt using the generative model. The system can receive one or more responses to the invocation from the external system. The system can generate the second (or any) generative model output based upon the received one or more responses.

In some implementations, each item of the second set of items is associated with a corresponding additional prompt for subsequent processing by the generative model. That is, as described above, there can be further sub-levels to the response/GUI.

At block 560, the system causes the second set of items to be visually rendered at the client device using a second set of GUI elements.

At block 562, the system determines an update for at least one prompt associated with the first set of items based upon a user interaction with the second set of GUI elements. For example, the system can determine one or more constraints based upon the user interaction with the second set of GUI elements and the system can determine an update for the at least one prompt based upon the determined one or more constraints.

In some implementations, the prompt(s) to be updated is different to the prompt corresponding to the selected GUI element of the first set of GUI elements. In other implementations, the prompt(s) to be updated includes the same prompt corresponding to the selected GUI element of the first set of GUI elements.

In some implementations, an item of the first set of items is associated with a plurality of sub-prompts. Determining an update for the at least one prompt can include determining an update for at least one sub-prompt of the plurality of sub-prompts.

In some implementations, the processing of FIG. 5 can further include updating the at least one prompt based upon determined update. The system can also process, using the GM, the updated prompt to generate third generative model output. The processing of the updated prompt to generate the third generative model output can be in response to receiving a user selection of a GUI element associated with the updated prompt. The system can cause the third generative model output to be visually rendered at the client device using a third set of GUI elements.

In some implementations, the system can also determine an update for at least one GUI element of the first set of GUI elements based upon the user interaction with the second set of GUI elements. For example, the GUI element of the first set of GUI elements can be updated to reflect a selection made by the user in the second set of GUI elements.

Turning now to FIG. 6, a block diagram of an example computing device 610 that may optionally be utilized to perform one or more aspects of techniques described herein is depicted. In some implementations, one or more of a client device, multi-modal response system component(s) or other cloud-based software application component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIGS. 1 and 2.

These software modules are generally executed by processor 614 alone or in combination with other processors. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, and includes: receiving user input associated with a user of a client device; processing, using a generative model, a generative model input based upon the user input to generate a first generative model output that includes a first set of items, where each item of the first set of items is associated with a corresponding prompt for subsequent processing by the generative model; causing the first set of items to be visually rendered at the client device using a first set of GUI elements; in response to receiving a user selection of a GUI element corresponding to an item of the first set of items, processing, using the generative model, the prompt associated with the selected item to generate second generative model output that includes a second set of items; causing the second set of items to be visually rendered at the client device using a second set of GUI elements; and determining an update for at least one prompt associated with the first set of items based upon a user interaction with the second set of GUI elements.

These and other implementations of technology disclosed herein can optionally include one or more of the following features.

In some implementations, the method may further include determining an updated prompt based upon the determined update; and processing, using the generative model, the updated prompt to generate third generative model output.

In further versions of those implementations, the method may further include causing the third generative model output to be visually rendered at the client device using a third set of GUI elements.

In some further versions of those implementations, the method may further include processing, using the generative model, the updated prompt to generate the third generative model output is in response to receiving a user selection of a GUI element associated with the updated prompt.

In additional or alternative further versions of those implementations, the prompt to be updated may be different to the prompt corresponding to the selected GUI element of the first set of GUI elements.

In additional or alternative further versions of those implementations, the prompt to be updated may be the same prompt corresponding to the selected GUI element of the first set of GUI elements.

In additional or alternative further versions of those implementations, the method may include determining one or more constraints based upon the user interaction with the second set of GUI elements; and wherein determining an update for at least one prompt is based upon the determined one or more constraints.

In additional or alternative versions of those implementations, an item of the first set of items may be associated with a plurality of sub-prompts; and determining an update for at least one prompt may include determining an update for at least one sub-prompt of the plurality of sub-prompt.

In additional or alternative versions of those implementations, each item of the second set of items may be associated with a corresponding additional prompt for subsequent processing by the generative model.

In additional or alternative versions of those implementations, the method further may include determining an update for at least one GUI element of the first set of GUI elements based upon the user interaction with the second set of GUI elements.

In additional or alternative versions of those implementations, at least one GUI element may be selected by the generative model.

In additional or alternative versions of those implementations, the first set of GUI elements may include a selectable tile for each item of the first set of items.

In some further versions of those implementations, a selectable tile may include a thumbnail image representative of the corresponding item.

In additional or alternative versions of those implementations, the first set of GUI elements may be arranged in a grid layout.

In additional or alternative versions of those implementations, the generative model may be based upon a large language model.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more computer readable storage media (e.g., transitory and/or non-transitory) storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
receiving user input associated with a user of a client device;
processing, using a generative model, a generative model input based upon the user input to generate a first generative model output that comprises a first set of items, wherein each item of the first set of items is associated with a corresponding prompt for subsequent processing by the generative model;
causing the first set of items to be visually rendered at the client device using a first set of GUI elements;
in response to receiving a user selection of a GUI element corresponding to an item of the first set of items, processing, using the generative model, the prompt associated with the selected item to generate second generative model output that comprises a second set of items;
causing the second set of items to be visually rendered at the client device using a second set of GUI elements; and
determining an update for at least one prompt associated with the first set of items based upon a user interaction with the second set of GUI elements.

2. The method of claim 1, wherein the method further comprises:
determining an updated prompt based upon the determined update; and
processing, using the generative model, the updated prompt to generate third generative model output.

3. The method of claim 2, wherein the method further comprises:
causing the third generative model output to be visually rendered at the client device using a third set of GUI elements.

4. The method of claim 3, wherein processing, using the generative model, the updated prompt to generate the third generative model output is in response to receiving a user selection of a GUI element associated with the updated prompt.

5. The method of claim 2, wherein the prompt to be updated is different to the prompt corresponding to the selected GUI element of the first set of GUI elements.

6. The method of claim 2, wherein the prompt to be updated is the same prompt corresponding to the selected GUI element of the first set of GUI elements.

7. The method of claim 1, wherein the method further comprises:
determining one or more constraints based upon the user interaction with the second set of GUI elements; and
wherein determining an update for at least one prompt is based upon the determined one or more constraints.

8. The method of claim 1, wherein processing, using the generative model, the prompt associated with selected item to the generate second generative model output comprises:
invoking an external application based upon processing the prompt using the generative model;
receiving, from the external application, one or more responses to the invocation; and
generating, by the generative model, the second generative model output based upon the one or more responses.

9. The method of claim 1, wherein an item of the first set of items is associated with a plurality of sub-prompts; and wherein determining an update for at least one prompt comprises determining an update for at least one sub-prompt of the plurality of sub-prompts.

10. The method of claim 1, wherein each item of the second set of items is associated with a corresponding additional prompt for subsequent processing by the generative model.

11. The method of claim 1, wherein the method further comprises:
determining an update for at least one GUI element of the first set of GUI elements based upon the user interaction with the second set of GUI elements.

12. The method of claim 1, wherein at least one GUI element is selected by the generative model.

13. The method of claim 1, wherein the first set of GUI elements comprises a selectable tile for each item of the first set of items.

14. The method of claim 13, wherein a selectable tile comprises a thumbnail image representative of the corresponding item.

15. The method of claim 13, wherein a selectable tile comprises a text caption representative of the corresponding item.

16. The method of claim 1, wherein the first set of GUI elements are arranged in a grid layout.

17. The method of claim 1, wherein the generative model is based upon a large language model.

18. A system comprising:
one or more processors; and
a memory storing computer readable instructions that, when executed by the one or more processors, causes the one or more processors to be operable to:
receive user input associated with a user of a client device;
process, using a generative model, a generative model input based upon the user input to generate a first generative model output that comprises a first set of items, wherein each item of the first set of items is associated with a corresponding prompt for subsequent processing by the generative model;
cause the first set of items to be visually rendered at the client device using a first set of GUI elements;
in response to receiving a user selection of a GUI element corresponding to an item of the first set of items, process, using the generative model, the prompt associated with the selected item to generate second generative model output that comprises a second set of items;
cause the second set of items to be visually rendered at the client device using a second set of GUI elements; and
determine an update for at least one prompt associated with the first set of items based upon a user interaction with the second set of GUI elements.

19. A non-transitory computer-readable storage medium storing instructions that, when executed by one or more processors, cause the one or more processors to perform operations, the operations comprising:
receiving user input associated with a user of a client device;
processing, using a generative model, a generative model input based upon the user input to generate a first generative model output that comprises a first set of items, wherein each item of the first set of items is associated with a corresponding prompt for subsequent processing by the generative model;
causing the first set of items to be visually rendered at the client device using a first set of GUI elements;
in response to receiving a user selection of a GUI element corresponding to an item of the first set of items, processing, using the generative model, the prompt associated with the selected item to generate second generative model output that comprises a second set of items;
causing the second set of items to be visually rendered at the client device using a second set of GUI elements; and
determining an update for at least one prompt associated with the first set of items based upon a user interaction with the second set of GUI elements.
